(19) United States
(12) Patent Application Publication
(10) Pub. No.: US 2016/0344744 A1
(43) Pub. Date: Nov. 24, 2016

(54) APPLICATION PROTOCOL QUERY FOR SECURING GBA USAGE

(71) Applicants: Gustavo TANONI, St-Lambert, Québec (CA); Patrik SALMELA, Espoo (FI); TELEFONAKTIEBOLAGET LM ERICSSON (PUBL), Stockholm (SE)

(72) Inventors: Gustavo Tanoni, St-Lambert, Quebec (CA); Patrik Salmela, Espoo (FI)

(21) Appl. No.: 14/421,879

(22) PCT Filed: Jan. 13, 2015
(86) PCT No.: PCT/IB2015/050256

§ 371 Date: Feb. 16, 2015

(51) Int. Cl. H04L 29/06; H04L 29/08; G06F 9/44; H04W 4/00

(52) U.S. Cl. CPC H04L 63/123; H04W 4/005; H04L 67/02; H04L 67/141; H04L 63/0876; G06F 9/4401; H04L 63/061

(57) ABSTRACT

A network element provides an application service to a device over a network. Using a shared key generated according to the Generic Bootstrapping Architecture (GBA), the network element authenticates a request message sent from the device. The network element sends to the device a response indicating a successful authentication. The response includes information that indicates one or more supported protocols for establishing a communication session between the device and the network element.

### TECHNICAL FIELD

Embodiments of the invention relate to the Generic Bootstrapping Architecture (GBA).

### BACKGROUND

In the Generic Bootstrapping Architecture (GBA) defined in the 3^{rd} Generation Partnership Project (3GPP) TS 33.220, a device with 3GPP credentials (e.g., a Subscriber Identity Module (SIM) card) can authenticate itself to a service using those credentials. The device first bootstraps with a Bootstrapping Server Function (BSF), which is located in the 3GPP operator network. This bootstrapping is performed using the Authentication and Key Agreement (AKA) procedure in which the device and the network are mutually authenticated. As a result of the mutual authentication, the device and the BSF generate a GBA master key (Ks) from the 3GPP credentials, and the BSF provides the device with a bootstrapping transaction identifier (B-TID) for the bootstrapping context.

When the device wants to use a GBA enabled application service (which is called the Network Application Function (NAF) in GBA), the device is requested by the NAF to authenticate itself. The device provides the NAF with the B-TID and authentication information (e.g., a Hypertext Transfer Protocol (HTTP) digest as defined in RFC 2617). The NAF then queries the BSF for a session key between itself and the device, and receives from the BSF a NAF specific session key (KsNAF). The device and the BSF can both generate KsNAF from the GBA master key and NAF_ID, which is based on the NAF's Fully Qualified Domain Name (FQDN). After the NAF receives KsNAF from the BSF, the NAF can use the key for authenticating the device by verifying the digest. Now the device has authenticated itself to the NAF. Further data exchange between the device and the NAF can continue with the HTTP or the HTTP based protocols.

The device's authentication to the NAF is performed over the Ua reference point, where the NAF specific key is used to authenticate the device and wherein further data exchange between the device and the NAF takes place. The protocol use by the Ua reference point has been standardized by 3GPP and is fixed to HTTP.

### SUMMARY

According to one embodiment, a method is provided to be performed by a network element. The network element provides an application service to a device over a network. The method comprises the steps of authenticating a request message from the device using a shared key generated according to the GBA, and sending to the device a response indicating a successful authentication. The response includes information that indicates one or more supported protocols for establishing a communication session between the device and the network element.

According to another embodiment, a network element provides an application service to a device over a network. The network element comprises a circuitry adapted to cause the network element to authenticate a request message from the device using a shared key generated according to the GBA, and to send to the device a response indicating a successful authentication. The response includes information that indicates one or more supported protocols for establishing a communication session between the device and the network element.

In one embodiment, the circuitry comprises a processor, a memory and an interface both coupled with the processor. The memory contains instructions that, when executed, cause the processor to authenticate a request message from the device using a shared key generated according to the GBA, and to send to the device a response indicating a successful authentication. The response includes information that indicates one or more supported protocols for establishing a communication session between the device and the network element.

According to yet another embodiment, a network element provides an application service to a device over a network. The network element comprises an authentication module adapted to authenticate a request message from the device using a shared key generated according to the GBA, and a sender module adapted to send to the device a response indicating a successful authentication. The response includes information that indicates one or more supported protocols for establishing a communication session between the device and the network element.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a simplified model of networked functional units involved in the GBA according to one embodiment.

FIG. 2 is a diagram illustrating a message flow between a device, a BSF and a NAF according to one embodiment.

FIG. 3 is a diagram illustrating a message flow between a device, a BSF and a NAF according to another embodiment.

FIG. 4 is a diagram illustrating a message flow between a device, a BSF and a NAF according to yet another embodiment.

FIG. 5 is a flow diagram illustrating a method of a network element that provides an application service to a device over a network according to one embodiment.

FIG. 6 illustrates a block diagram of a network element according to one embodiment.

FIG. 7 illustrates a block diagram of a network element according to another embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The 3GPP has standardized the protocol use by the Ua reference point as being fixed to HTTP. The 3GPP does not specify how other protocols can be used. To specify the use of a protocol other than HTTP on the Ua reference point needs further research and standardization efforts. However, in some scenarios a different protocol than HTTP is desired; e.g., for the purpose of improving the security and data integrity. If the device wants to use a different protocol (e.g., the Constrained Application Protocol (CoAP)), it would have to try sending a CoAP message to the NAF to see if the NAF responds to the message and indicates support for CoAP. This kind of blindly trying different options is not only inefficient and time consuming, but can be futile for the devices.

Embodiments of the invention provide a mechanism for the NAF to inform a device of available protocols, port and/or security requirements in addition to the standard HTTP option. In addition, the NAF can inform the device of different security requirements for different resources that the NAF possesses. In one embodiment, the NAF can inform the device of available resources and/or protocols on a per user level.

In the standard GBA (as defined by 3GPP TS 33.220), upon successful authentication of a device, the NAF sends an “authentication successful” reply (e.g., a HTTP 200 OK message) to the device. Embodiments of the invention enable the NAF to embed additional information into this reply; e.g., about which security protocols and ports that the NAF supports. The device can parse this information and then choose a suitable protocol to continue the communication with the NAF. In one embodiment the device has a screen and a user input mechanism, such that the device can present the protocol options to the user and the user can determine which protocols to use. The mechanism described herein expands the protocol choice for the device to communicate with the NAF; without this mechanism, the device and the NAF can communicate in HTTP or HTTP based protocols only and no other protocols at all.

Embodiments of the invention add flexibility to the communication between the device and the NAF, and allow the NAF to secure multiple resources in different ways. For example, the NAF can, in the “authentication successful” reply to the device, include information about which security protocols and ports are supported. The NAF may provide this information for each supported resource if these resources have different security requirements. In addition, the NAT can learn from the response from the BSF about what rights the authenticated user has, and thus provide the user with a reply that gives an exact access control limit on a per user basis. The response from the BSF can also contain information about limitations and/or capabilities of the device's subscription (e.g., no CoAP), so that the NAF can reply with only valid options for the device.

The flexibility in protocol usage is especially beneficial for constrained devices that might not support HTTP at all. Constrained devices, such as machine-to-machine (M2M) devices, are constrained with respect to resources in that they typically have limited memory and power. Using the additional information in the “authentication successful” reply described herein, upon successful authentication the device can learn from the NAF which security protocols the NAF supports and can see if any of them matches what the device itself supports.

In the following description, the terms “user” and “subscriber” are used interchangeably to mean the person or entity that owns a subscription to a mobile communication service. The terms “reply” and “response” are also used interchangeably. Moreover, the term “user” herein refers to the user of a device where the device has a mobile subscription owned by the user. Therefore, as used herein, information that is specific to a device is also specific to a user, which in turn is also specific to a subscription.

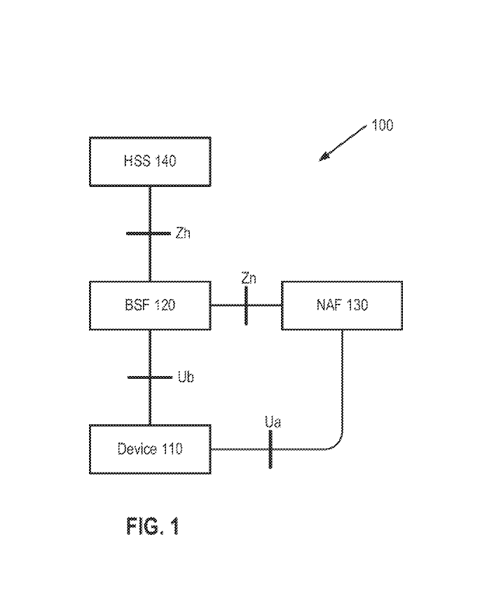

FIG. 1 illustrates a simplified model 100 of networked functional units involved in the GBA according to one embodiment. The model 100 includes a device 110, a BSF 120, a. NAF 130 and a Home Subscriber System (HSS) 140. In some embodiments, some (i.e., two or more) of the BSF 120, the NAF 130 and the HSS 140 may be collocated in the same physical network element, such as a network server, an application server or other network devices. Alternative embodiments may include additional networked functional units but they are outside the scope of this disclosure. The interfaces (or “reference points” in 3GPP terminology) “Ua”, “Ub”, “Zh” and Zn” shown in FIG. 1 are defined according to the 3GPP standard.

In one embodiment, the device 110 includes a Universal Integrated Circuit Card (UICC); for example, a SIM card, that stores its 3GPP credentials (such as the identity and the related keys of a subscriber that uses the device 110). The device 110 may be a user equipment (“UE”, e.g., a cellular phone, a laptop computer), a constrained device (e.g., a sensor, an actuator, or any M2M device) or any mobile device that receives the mobile communication service from a mobile network operator. However, for the purpose of GBA, Internet Protocol (IP) connectivity such as Wi-Fi connection or other Internet access capabilities are sufficient for the device 110. The device 110 may, but is not required to, use 3GPP mobile network access for the purpose of GBA.

The HSS 140 is typically operated by a mobile network operator to store user profile information and subscription related information. The BSF 120 is an intermediate functional unit located between the HSS 140 and the device 110. The BSF 120 communicates with the HSS 140 over the Zh reference point. Using the 3GPP credentials of the device 110, the BSF 120 and the device 110 can mutually authenticate over the Ub reference point. The NAF 130 provides application services; e.g., Web services or any Internet accessible services. When the device 110 requests the NAF 130 for its application services, the NAF 130 in turn requests the BSF 120 over the Zn reference point for a shared secret (i.e., the key KsNAF, which is generated by the BSF 120 and the device 110). In addition to the key, the BSF 120 can also provide the NAF 130 with the User Security Settings (USS), if available. The USS is based on the information that the BSF 120 received from the HSS 140, and is specific to the user and the NAF 130. The NAF 130 uses the shared key to authenticate the device 110 over the Ua reference point. After the authentication, this key can be used for secure communication in many ways, as long as the NAF 130 and the device 110 can agree on how the key is used. For example, the key KsNAF can be used as a session key for establishing a secure communication session between the device 110 and the NAF 130. Moreover, for example, when using the Transport Layer Security (TLS) (as defined by 3GPP TS 33.222) with the key KsNAF, the key can be used as a pre-shared key (PSK) to secure the HTTP communication between the device 110 and the NAF 130.

After successfully authenticating the device 110, the NAF 130 sends a response to the device 110 over the Ua reference point to indicate the successful authentication. Embodiments of the invention allow the NAF 130 to provide information to the device 120 in addition to the indication of the successful authentication. For example, the information may contain one or more protocols supported by the NAF 130, including or in addition to the protocol that the device 110 and the NAF 130 have used for authenticating the device 110.

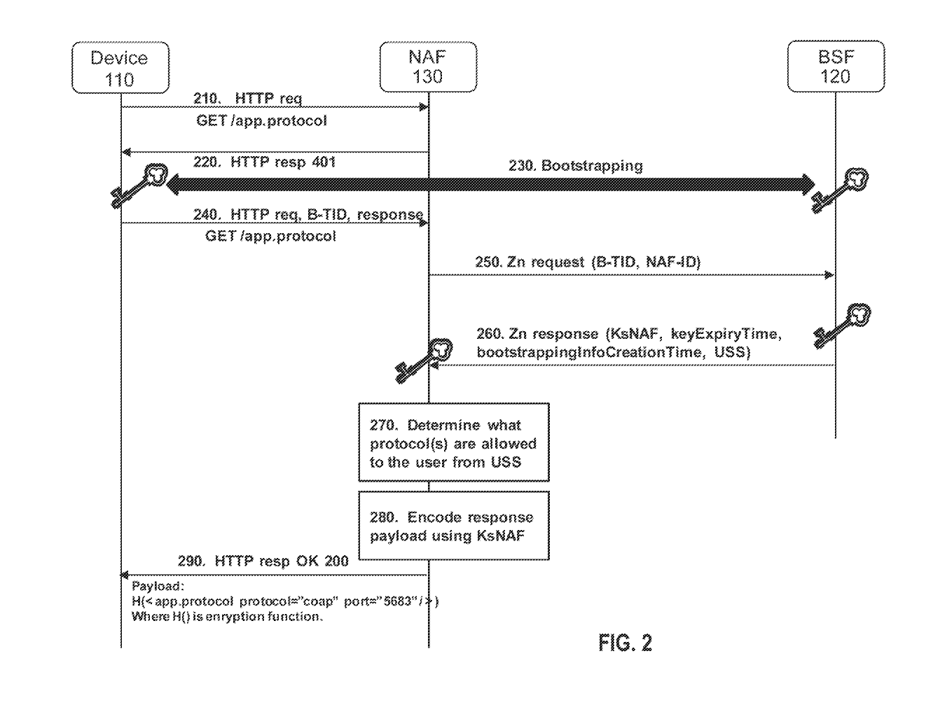

FIG. 2 is a diagram illustrating the message flow between the device 110, the BSF 120 and the NAF 130 according to one embodiment. The device 110 first connects to the NAF 130, and sends an initial request to the NAF 130 for an application service (step 210). In FIG. 2, the initial request includes “GET /app.protocol” to indicate that the device 110 is asking for the NAF 130 to provide a list of supported protocols (in addition to the protocol with which the device 110 sends the initial request). Alternatively, the initial request may include a request for an action on any specific resource; e.g., GET /index.html, POST or PUT an entity, etc. Alternatively, the initial request may include no indication for any specific resource; that is, the HTTP request in step 210 does not include GET /app.protocol or any request for an action on specific resources. The usage of “app.protocol” will be explained in further detail at the end of the message flow.

In response to the initial request, the NAF 130 replies with a HTTP 401 authentication request message, indicating that the device needs to he authenticated (step 220) The device 110 then mutually authenticates with the BSF 120 according to the AKA procedure (step 230), from Which the device 110 receives its B-TID. Using the device's 3GPP credentials and the NAF identifier (e.g., based on the FQDN), the device generates the NAF specific key (KsNAF). The device 110 calculates a digest using KsNAF and other information exchanged with the NAF 130 and the BSF 120, and sends a request message including the digest and the B-TID to the NAF 130 (step 240). In FIG. 2, the request message includes “GET /app.protocol” to indicate that the device 110 is asking for the NAF 130 to provide a list of supported protocols (in addition to the protocol that the device 110 and the NAF 130 have been exchanging messages with). Alternatively, the request message may include a request for an action on any specific resource, or no indication for any specific resource; that is, the HTTP request in step 240 does not include GET /app.protocol or any indication to get specific resources. The usage of “app.protocol” will be explained in further detail at the end of the message flow.

Upon receiving the request message, the NAF 130 sends the B-TID and its own identifier (NAF-ID) to the BSF 120 (step 250). In response, the NAF 130 receives a time-limited NAF specific key (KsNAF), the key expiration time, the bootstrapping information creation time, and the USS, among other information (step 260). The NAF 130 and the device 110 now share a secret key, i.e., KsNAF. Using KsNAF, the NAF 130 can verify the digest. If the digest is verified, the NAF 130 knows that the device 110 has successfully authenticated with the BSF 120. Thus, the device 110 is successfully authenticated to the NAF 130.

Based on the USS from the BSF 120 and the policy of the NAF, the NAF 130 determines user-specific information, e.g., which resource(s) are available to the user and/or which protocol(s) are allowed to the user (step 270). The NAF 130 then sends a response (e.g., HTTP 200 OK message) to the device 110 indicating the successful authentication of the device 110, and, in addition, the response includes information such as supported protocols. In one embodiment, the NAF 130 may encode the additional information with KsNAF (step 280). The NAF 130 then sends the response to the device (step 290), which in this example specifically indicates a protocol and a port available to the user. The NAF 130 may indicate more than one supported protocol in the response. Thus, the device 110 may select one of the supported protocols for establishing a secure communication session with the NAF 130.

In steps 210 and 240 of FIG. 2, the device's HTTP requests include a reference to a designated resource “GET/ app.protocol” to indicate that the device 110 is asking the NAF 130 for supported protocols. This “app,protocol” is designated for a device to request supported protocol information, and any additional information available to the device. In one embodiment, when the device 110 requests for this designated resource (e.g., when the device's HTTP request in step 240 includes “GET/ app.protocol”), the NAF 130 will respond with the supported protocol information in the HTTP 200 OK message. Otherwise (e.g., when GET/ app.protocol is absent from the device's HTTP request in step 240), the NAF 200 will send the HTTP 200 OK message without the supported protocol information, as in the standard GBA. In this embodiment, the device's initial request in step 210 may include a request for a specific resource, or may include no indication for any specific resource.

In alternative embodiments, the NAF 130 responds with the supported protocol information (and other available information if any) in the HTTP 200 OK message regardless of whether “GET/ app.protocol” is present in the device's request message in step 240. That is, the device's request message in step 240 may include no indication for any specific resource, and the NAF 130 will still respond with the supported protocol information in the HTTP 200 OK message. The device's request message in step 240 may alternatively include a request for an action on a specific resource different from “GET/ app.protocol,” and the NAF 130 will still respond with the supported protocol information in the HTTP 200 OK message. The supported protocol information may be added to the actual response to the device's request. For example, if the device's request is for index.html, then the NAF's response will include the content of index.html and the additional information such as supported protocols. The NAF 130 may encode the additional information portion of the response with KsNAF; the rest of the response is sent according to the GBA standard (i.e., not encoded with KsNAF). In these alternative embodiments, the device's initial request in step 210 may include a request for a specific resource, or may include no indication for any specific resource.

In step 270 of FIG. 2, the USS received from the BSF 120 and the policy of the NAF 130 can contain service-specific polices and configuration for the device's 3GPP subscription. These policies can indicate which resources of the service (the NAF 130) that the device 110 (more specifically, the subscription or the user owning the subscription) is allowed to access. The NAF 130 can embed into its response (e.g., the HTTP 200 OK message) additional information for helping the device 110 with further communication. The additional information may include which protocol/port pairs that the NAF 130 supports, e.g., HTTP/TLS:port 443 or CoAP/DTLS:port 5683. The NAF 130 can thus tell the device 110 the possible ways that the NAF 130 can be connected to.

In addition to the protocol/port information, the NAF 130 may also add into its response (e.g., the HTTP 200 OK message) one or more of the following, including but not limited to:

Crypto parameters for the given protocols, such as supported cipher suits. The cipher suits can play a role when the device 110 selects in what way it is to be connected to the NAF 130.

Per resource protocols. Some of the resources hosted by the NAF 130 may only accept specific protocols. For example, some resources may only accept HTTP/TLS while other resources may also accept CoAP/DTLS (Datagram TLS).

Per user information. The NAF 130 may provide only the resources that are available to this particular device 110 based on the information received in the USS from the BSF 120 and the policy of the NAF 130. The USS and the NAF policy may also limit which protocols that the device 110 is allowed to use towards this service.

Key KsNAF identifier. The NAF 130 may be requested to provide an application service to multiple devices, and may use a different KsNAF for each device. The NAF 130 can use an identifier to distinguish which device is initiating a connection to receive the application service, and which KsNAF is to be used for the connection. The B-TID may be used for identifying the key KsNAF. However, in some selected security protocols, the B-TID may not be suitable to be used (e.g., the B-TID may be too long). In one alternative embodiment, the NAF 130 can generate its own identifiers. This identifier can be sent to the device 110 in the authentication successful response, and can be used to identify the shared key when the device 110 establishes a new session based on the information it has learned from the NAF 130.

Once the device 110 receives the above-mentioned information embedded in the NAF's response, the device 110 can select, from the options presented, the most suitable way of communicating with and securing the communication to the NAF 130.

In step 290 of FIG. 2, the NAF 130 encodes the response payload with KsNAF. Alternatively, the NAF 130 may calculate a Message Authentication Code (MAC), encrypt and/or sign this embedded information in the response payload using the shared key KsNAF. This way, the NAF 130 will not reveal this embedded information about available resources or device-specific information to an eavesdropper and can protect the information against modifications. The device 110 can decrypt this embedded information using the shared key KsNAF which the device 110 also possesses. To allow the device 110 to decrypt the information, the NAF 130 can use some pre-defined default encryption algorithm, or the NAF 130 can indicate to the device 110 which algorithm has been used (e.g., by embedding relevant information to the HTTP 200 OK message).

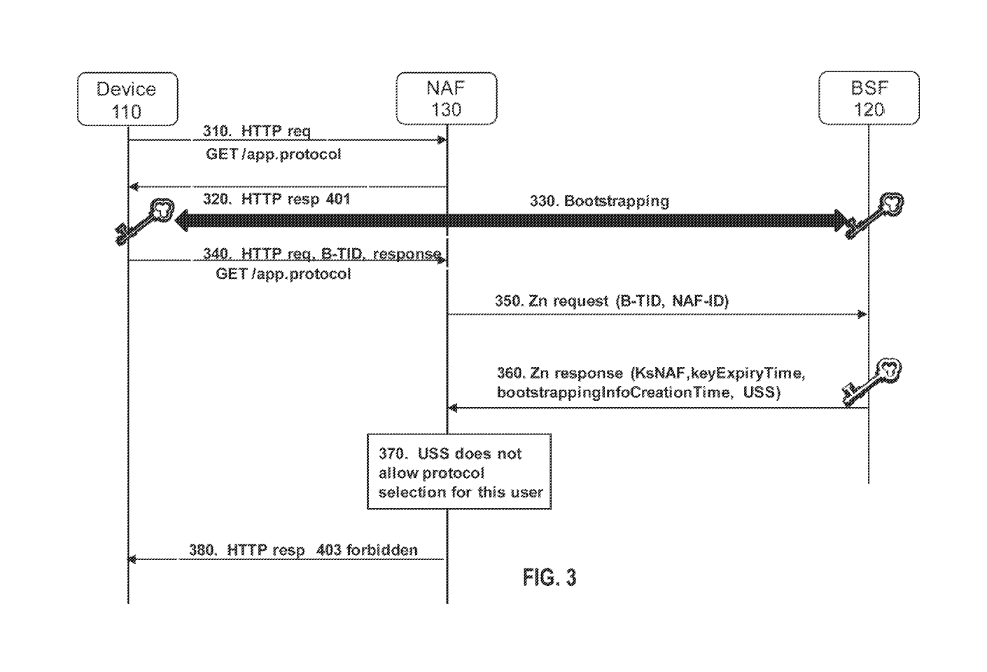

In one embodiment, the USS received from the BSF 120 or a policy of the NAF 130 may indicate that the device 110 is prohibited from requesting for supported protocols. When the device 110 requests for supported protocols (e.g., by sending a request for the resource using “app.protocol”), the NAF 130 can reply with a HTTP 403 denied message. Alternatively, the NAF 130 can, instead of the list of supported protocols, embed a note indicating that the device 110 is not allowed to query this information. FIG. 3 provides an example in which the device 110 is not allowed to perform an explicit protocol selection.

FIG. 3 is a diagram illustrating the message flow among the device 110, the BSF 120 and the NAF 130 according to another embodiment. Steps 310-360 are the same as steps 210-260 in FIG. 2. However, the USS in the message that the NAF 130 receives from the BSF 120 indicates that the user is blocked from protocol selection (step 370). The NAF 130 then sends a reply to the device 110 with a HTTP 403 response indicating that the request is forbidden (step 380).

It is noted that the messages exchanges in steps 210-230 of FIG. 2 and steps 310-330 of FIG. 3 can be performed in a different order from what is shown. For example, the device 110 may have bootstrapped with the BSF 120 at some earlier point (before the device 110 sends the initial request to the NAF 130 at steps 210 and 310), and already has a valid bootstrapping context with the BSF 120 before sending that initial request. After bootstrapping with the BSF 120, the device 110 sends the initial request. The message flow then continues from steps 240 and step 340 as described in FIG. 2 and FIG. 3, respectively.

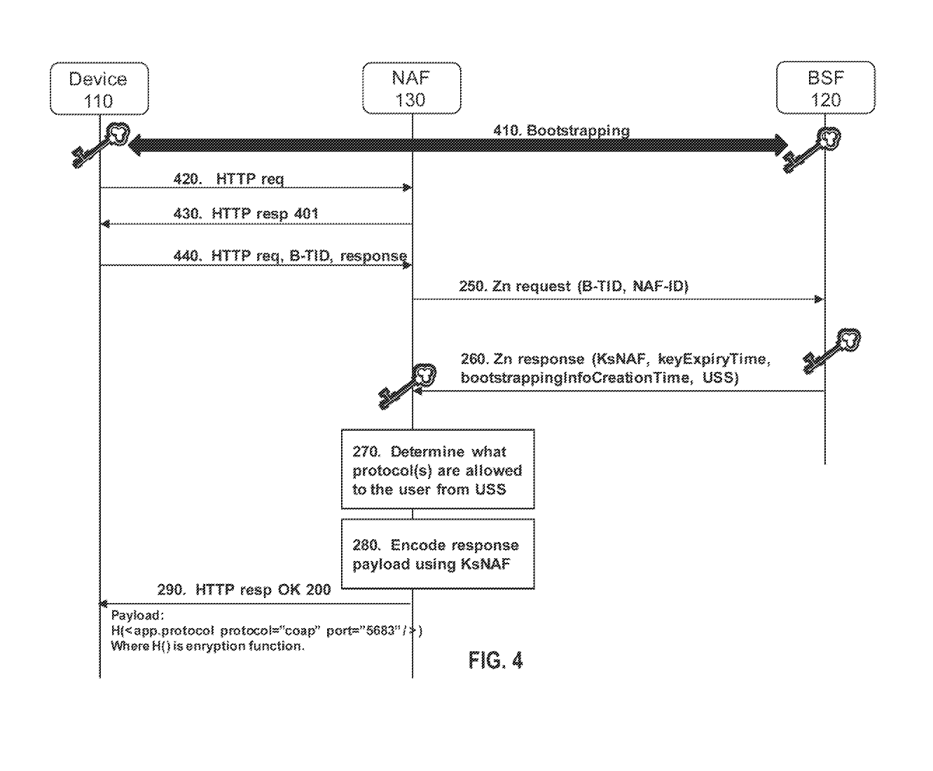

FIG. 4 s a diagram illustrating the message flow among the device 110, the BSF 120 and the NAF 130 according to yet another embodiment, in which bootstrapping with the BSF 120 is performed (step 410) before the device 110 sends the initial request to the NAF 130 (step 420). In response to the initial request, the NAF 130 sends an authentication request (e.g., HTTP response 401) to the device 110 (step 430). The device 110 then sends a request message (step 440) which is authenticated by the NAF 130. In this embodiment, the message exchanges after step 440 proceed in the same way as in FIG. 2; in an alternative embodiment the device's request may be rejected as in FIG. 3. Further, this embodiment illustrates the scenario in which the device's requests at steps 410 and 440 do not specify a resource; nevertheless, the NAF 130 responds to the device's authenticated request (i.e., the request message in step 440) with the supported protocol information in the HTTP 200 OK message.

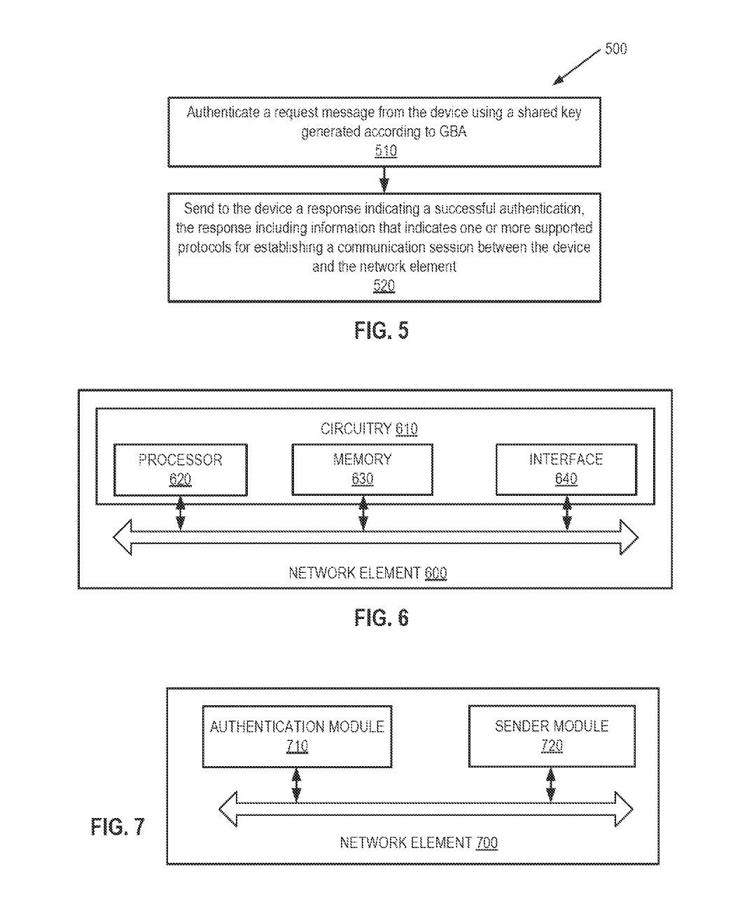

FIG. 5 is a flow diagram illustrating a method 500 for a network element that provides an application service to a device over a network according to one embodiment. The method 500 begins when the network element authenticates a request message from the device using a shared key generated in accordance to the GBA (block 510). The network element further sends to the device a response indicating a successful authentication. The response includes information that indicates one or more supported protocols for establishing a communication session between the device and the network element (block 520). In one embodiment, the request message is sent by the device in response to an authentication request from the network element. The request message may include a request for supported protocols. Alternatively, the request message may include a request for an action on a specific resource, or no indication for any specific resource. In one embodiment, after sending the response indicating a successful authentication, the network element may receive from the device an indication that one of the supported protocols is used for the communication session between the device and the network element. In one embodiment, the network element performs the function of the NAF 130 of FIGS. 1-4.

The method 500 may be performed by hardware (e.g., circuitry, dedicated logic, programmable logic, microcode, etc.), software (e.g., instructions run on a processing device), or a combination thereof. In one embodiment, the method 500 may be performed by a network element 600 of FIG. 6 and/or by a network element 700 of FIG. 7.

FIG. 6 illustrates a network element 600 that provides an application service to a device over a network according to one embodiment. The network element 600 includes circuitry 610 adapted to cause the network element 600 to perform the method 500. In one embodiment, the circuitry 610 includes a processor 620, a memory 630 and an interface 640. Both the memory 630 and the interface 640 are coupled with the processor 620. The memory 630 contains instructions that when executed cause the processor 620 to perform the method 500. The processor 620 may include one or more general-purpose processing units and/or one or more special-purpose processing units, each of which can be: a microprocessor, a central processing unit (CPU), a multi-core processing unit, an application specific integrated circuit (ASIC), a field programmable gate array (FPGA), a digital signal processor (DSP), a network processor, etc. The memory 630 may include a main memory (e.g., read-only memory (ROM), flash memory, dynamic random access memory (DRAM), etc.), a secondary memory (e.g., a magnetic data storage device, an optical magnetic data storage device, etc.), and different forms of ROMs, different forms of random access memories (RAMs), static RAM (SRAM), or any type of media suitable for storing instructions.

FIG. 7 illustrates a network element 700 that provides an application service to a device over a network according to another embodiment. The network element 700 includes an authentication module 710 adapted to authenticate a request message sent from the device using a shared key generated according to the GBA, and a sender module 720 adapted to send to the device a response indicating a successful authentication. The response includes information that indicates one or more supported protocols for establishing a communication session between the device and the network element.

The operations of the diagrams of FIGS. 2-5 have been described with reference to the exemplary embodiments of FIGS. 6 and 7. However, it should be understood that the operations of the diagrams of FIGS. 2-5 can be performed by embodiments of the invention other than those discussed with reference to FIGS. 6 and 7, and the embodiments discussed with reference to FIGS. 6 and 7 can perform operations different than those discussed with reference to the diagrams. While the diagrams of FIGS. 2-5 show a particular order of operations performed by certain embodiments of the invention, it should be understood that such order is exemplary (e.g., alternative embodiments may perform the operations in a different order, combine certain operations, overlap certain operations, etc.).

It is to be understood that the above description is intended to be illustrative, and not restrictive. Many other embodiments will be apparent to those of skill in the art upon reading and understanding the above description. Accordingly, the specification and drawings are to be regarded in an illustrative sense rather than a restrictive sense.

1. A method of a network element that provides an application service to a device over a network, the method comprising:
authenticating a request message from the device using a shared key generated according to Generic Bootstrapping Architecture (GBA); and
sending to the device a response indicating a successful authentication, the response including information that indicates one or more supported protocols for establishing a communication session between the device and the network element.

2. The method of claim 1, wherein the information further comprises supported ports for the one or more supported protocols.

3. The method of claim 1, wherein the information further comprises cryptographic parameters for the one or more supported protocols.

4. The method of claim 1, wherein the information indicates at least a supported protocol specific to a resource hosted by the network element.

5. The method of claim 1, further comprising:
sending an authentication request to the device; and
receiving the request message from the device in response to the authentication request, wherein the request message includes a request for protocols supported by the network element.

6. The method of claim 1, further comprising:
sending an authentication request to the device; and
receiving the request message from the device in response to the authentication request, wherein the request message includes no indication for a specific resource.

7. The method of claim 1, further comprising:
sending an authentication request to the device;
receiving the request message from the device in response to the authentication request, wherein the request message includes a request for an action on a specific resource; and
sending to the device the response including a reply to the request for the action.

8. The method of claim 1, further comprising:
receiving user-specific information from a second network element in the network; and
determining, based on at least the user-specific information, which protocols supported by the network element are allowed to be used by the device.

9. The method of claim 1, further comprising:
receiving user-specific information from a second network element in the network; and
determining, based on at least the user-specific information, which resources of the network element are available to the device.

10. The method of claim 1, further comprising:
generating an identifier for identifying a key to be used by the device when communicating with the network element; and
sending the response containing the identifier to the device.

11. The method of claim 1, further comprising:
applying a cryptographic function to the information before sending the response to the device.

12. The method of claim 1, further comprising:
receiving from the device an indication that one of the supported protocols is used for the communication session between the device and the network element.

13. A network element for providing an application service to a device over a network, the network element comprising:
a circuitry adapted to cause the network element to:
authenticate a request message from the device using a shared key generated according to Generic Bootstrapping Architecture (GBA); and
send to the device a response indicating a successful authentication, the response including information that indicates one or more supported protocols for establishing a communication session between the device and the network element.

14. The network element of claim 13, wherein the circuitry comprises a processor, a memory and an interface both coupled with the processor, the memory containing instructions that when executed cause the processor to:
authenticate a request message from the device using a shared key generated according to Generic Bootstrapping Architecture (GBA); and
send to the device a response indicating a successful authentication, the response including information that indicates one or more supported protocols for establishing a communication session between the device and the network element.

15. The network element of claim 14, wherein the information further comprises supported ports for the one or more supported protocols.

16. The network element of claim 14, wherein the information further comprises cryptographic parameters for the one or more supported protocols.

17. The network element of claim 14, wherein the information indicates at least a supported protocol specific to a resource hosted by the network element.

18. The network element of claim 14, wherein the memory (630) containing instructions that when executed further cause the processor to send an authentication request to the device, and wherein the request message, which is sent from the device in response to the authentication request, includes a request for protocols supported by the network element.

19. The network element of claim 14, wherein the memory containing instructions that when executed further cause the processor to send an authentication request to the device, and wherein the request message, which is sent from the device in response to the authentication request, includes no indication for a specific resource.

20. The network element of claim 14, wherein the memory containing instructions that when executed further cause the processor to send an authentication request to the device, and wherein the request message, which is sent from the device in response to the authentication request, includes a reply for an action on a specific resource.

21. The network element of claim 14, wherein the memory (630) containing instructions that when executed further cause the processor to:
receive user-specific information from a second network element in the network; and
determine, based on at least the user-specific information, which protocols supported by the network element are allowed to be used by the device.

22. The network element of claim 14, wherein the memory containing instructions that when executed further cause the processor to:
receive user-specific information from a second network element in the network; and
determine, based on at least the user-specific information, which resources of the network element are available to the device.

23. The network element of claim 14, wherein the memory (630) containing instructions that when executed further cause the processor to:
generate an identifier for identifying a key to be used by the device when communicating with the network element; and
send the response containing the identifier to the device.

24. The network element of claim 14, wherein the memory containing instructions that when executed further cause the processor to apply a cryptographic function to the information before sending the response to the device.

25. The network element of claim 14, wherein the memory (630) containing instructions that when executed further cause the processor to receive from the device an indication that one of the supported protocols is used for the communication session between the device and the network element.

26. (canceled)
